(19) United States
(12) Patent Application Publication
(10) Pub. No.: US 2017/0357724 A1
(43) Pub. Date: Dec. 14, 2017

(54) MODEL INDEPENDENT AND NETWORK STRUCTURE DRIVEN RANKING OF NODES FOR LIMITING THE SPREAD OF MISINFORMATION THROUGH LOCATION BASED SOCIAL NETWORKS

(71) Applicant: International Business Machines Corporation, Armonk, NY (US)

(72) Inventors: Krishnasuri Narayanam, Bangalore (IN); Ramasuri Narayanam, Bangalore (IN); Mukundan Sundararajan, Bangalore (IN)

(21) Appl. No.: 15/181,856

(22) Filed: Jun. 14, 2016

(51) Int. Cl. G06F 17/30

(52) U.S. Cl. CPC G06F 17/30867; G06F 17/3053

(57) ABSTRACT

A method of limiting misinformation spread through a social network structure using a ranking of nodes of a targeted portion of a social network. Limiting the misinformation spread may be accomplished by: generating a set of permutations of the nodes of the targeted social network; computing a contribution to the spread of influence of each node within the set of randomly generated permutations; determining the average contribution of each of the nodes towards a spread of information within the network; constructing a list of ranked nodes by sorting the nodes in a non-increasing order based on contribution values; and disconnecting at least some of the nodes in order of rank in the list.

### BACKGROUND

The present invention relates to ranking of nodes in a network structure, and more specifically to a network structure driven ranking of nodes for limiting the spread of misinformation through location based social networks.

At times negative information (e.g. rumors or viral marketing campaigns), misinformation, or false or inaccurate information (especially that which is deliberately intended to deceive), originates and is spread through a social network. To combat the spread of the negative information or misinformation, specific models are used in prior art systems to aid in preventing the spread of misinformation. Based on the specific models, nodes of the social network are targeted to limit the spread of misinformation. Identifying the nodes to target is difficult.

### SUMMARY

According to one embodiment of the present invention, a method of limiting misinformation spread through a social network structure using a ranking of nodes of a targeted portion of a social network is disclosed. The method comprising the steps of: a computer randomly generating a set of permutations of the nodes of the targeted social network; the computer computing a contribution to the spread of influence of each node within the set of randomly generated permutations; the computer, determining the average contribution of each of the nodes towards a spread of information within the network; the computer constructing a list of ranked nodes by sorting the nodes in a non-increasing order based on contribution values; and the computer disconnecting at least some of the nodes in order of rank in the list.

According to another embodiment of the present invention, a computer program product for limiting misinformation spread through a social network structure using a ranking of nodes of a targeted portion of a social network is disclosed. The computer program product comprising a computer comprising at least one processor, one or more memories, one or more computer readable storage media, the computer program product comprising a computer readable storage medium having program instructions embodied therewith. The program instructions executable by the computer to perform a method comprising: randomly generating, by the computer, a set of permutations of the nodes of the targeted social network; computing, by the computer, a contribution to the spread of influence of each node within the set of randomly generated permutations; determining, by the computer, the average contribution of each of the nodes towards a spread of information within the network; constructing, by the computer, a list of ranked nodes by sorting the nodes in a non-increasing order based on contribution values; and disconnecting, by the computer, at least some of the nodes in order of rank in the list.

According to another embodiment of the present invention, a computer system for limiting misinformation spread through a social network structure using a ranking of nodes of a targeted portion of a social network is disclosed. The computer system comprising a computer comprising at least one processor, one or more memories, one or more computer readable storage media having program instructions executable by the computer to perform the program instructions. The program instructions comprising: randomly generating, by the computer, a set of permutations of the nodes of the targeted social network; computing, by the computer, a contribution to the spread of influence of each node within the set of randomly generated permutations; determining, by the computer, the average contribution of each of the nodes towards a spread of information within the network; constructing, by the computer, a list of ranked nodes by sorting the nodes in a non-increasing order based on contribution values; and disconnecting, by the computer, at least some of the nodes in order of rank in the list.

### BRIEF DESCRIPTION OF THE SEVERAL VIEWS OF THE DRAWINGS

FIG. 1 depicts a cloud computing node according to an embodiment of the present invention.

FIG. 2 depicts abstraction model layers according to an embodiment of the present invention.

FIG. 3 shows a diagram of nodes of a social network at a targeted geographic location.

FIG. 4 shows a diagram of identifying and preventing the spread of misinformation in social networks.

FIG. 5 shows a flow diagram of a method of model independent ranking and network structure driven ranking if nodes of limiting the spread of misinformation through location based social networks.

### DETAILED DESCRIPTION

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

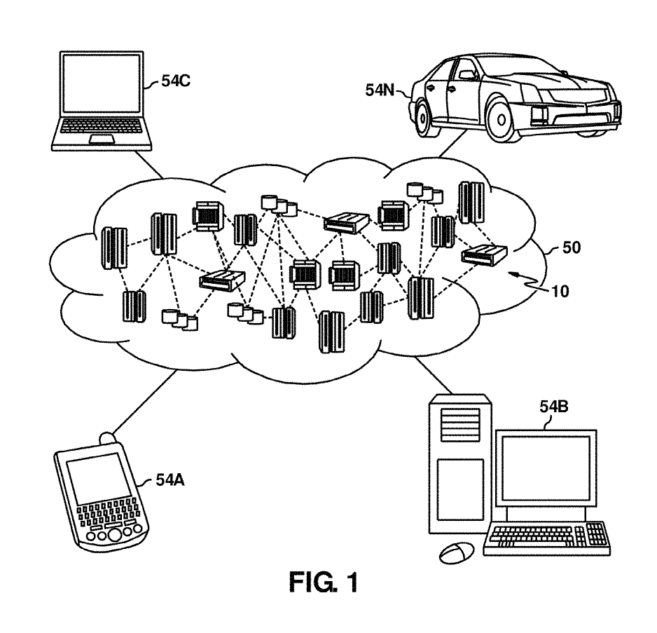

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

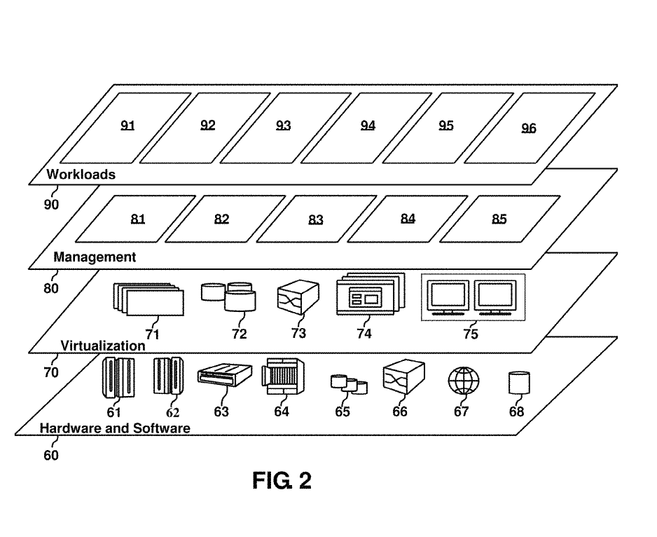

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; computers, and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and misinformation management 96.

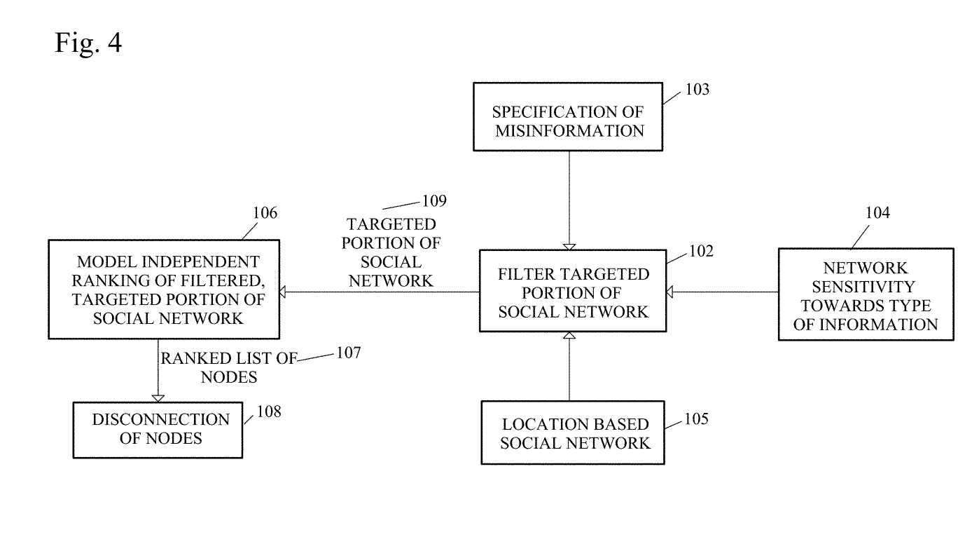

FIG. 4 shows a diagram of identifying and preventing the spread of misinformation in social networks.

A targeted portion of social network comprised of targeted portions of the social network of nodes affected by the misinformation may be filtered 102 by receiving specifications regarding the misinformation 103, input regarding the portions of the user base of the social network which are sensitive towards the misinformation 104, and input regarding the geography or location of the user base of the social network 105 which includes the social network itself.

The social network prior to the filtering may be represented mathematically as G(N, E(N)), wherein G represents “graph”, N represents nodes of the network and E represents edges or connections between the nodes N.

Based on the input received, the nodes of the social network which do not correspond to the input received are removed or filtered out 102, leaving a targeted portion of the network 109 which is provided as input for further ranking 106.

The targeted portion of the social network from the filtering 102 may be represented mathematically as G(N\S, E(N\S)), where G represents “graph”, N represents nodes of the network, E represents edges or connections between the nodes and S represents a subset of nodes, indicating that nodes were removed in the subset along with edges amount the nodes in the subset.

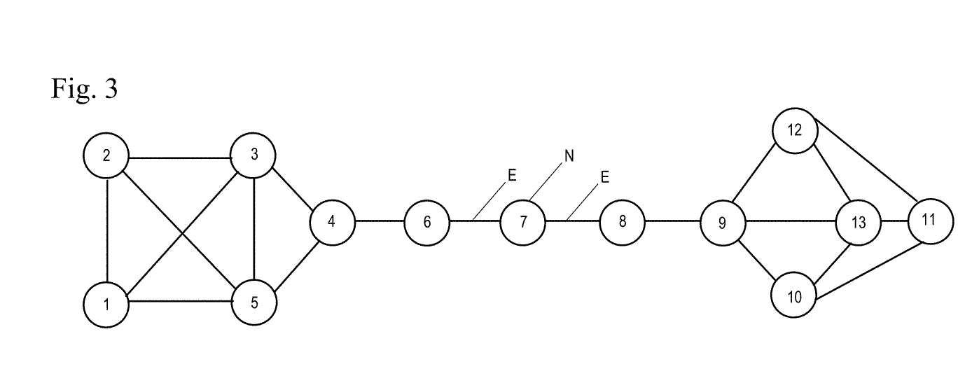

An example of a targeted portion of a social network of nodes is shown in FIG. 3. The targeted portion of the social network is represented by nodes N, where N={1, 2, 3, 4, 5, 6, 7, 8, 9, 10, 11, 12, 13}, and preferably includes all of the connections (edges) E between said nodes N. Nodes 1-13 represent a portion of a much larger network in a geographic location that has N nodes. Misinformation may be found in any of the nodes.

In the example of FIG. 3, Nodes 1, 2, 3, and 5 are all interconnected through edges represented by the lines between the nodes. Node 4 is connected to node 3 and node 5. Node 4 is connected to node 6. Node 6 is connected to node 7. Node 8 is connected to node 9. Node 9 is connected to node 12, 13 and 10. Node 11 is connected to nodes 10, 13, and 12. Node 12 is connected to node 9, 11, and 13. Node 13 is connected to node 9, 10, 11, and 12. Node 10 is connected to 9, 13 and 11.

The nodes 1-13 of the targeted portion of the social network from 102 are ranked 106 using a model independent ranking method of the present invention. The model independent ranking 106 outputs a ranked list of nodes 107 of a social network which may need to be targeted to slow down (e.g. decrease the speed in which the misinformation is spreading) and/or prevent the spread of misinformation.

The model independent ranking 106 of the present invention uses ranking mechanisms which take into account a synergy effect. The synergy effect is a level of impact or effect when multiple nodes interact together. To take into account the synergy effect, the model independent ranking 106 analyzes subsets of nodes, not just the individual nodes. For example, referring to FIG. 3, nodes 9 and 4 may be selected as ranking first and second as to the nodes which need to be disconnected to prevent and decrease the speed of misinformation spreading between nodes 1, 2, 3, 5 to nodes 6-13.

The ranked list of nodes 107 provides Shapley values of the nodes using a sampling-based approach that works in polynomial time. Shapley values are used in this case since the contributions of each node are unequal. As a result, each node gains more value with each connection to other nodes, so that a node with more than one connection has more significance than it would have if it were acting independently.

Based on the ranked list of nodes 107, specific nodes may be disconnected 108 from the social network, decreasing or preventing the misinformation from spreading within the social network at a specific location.

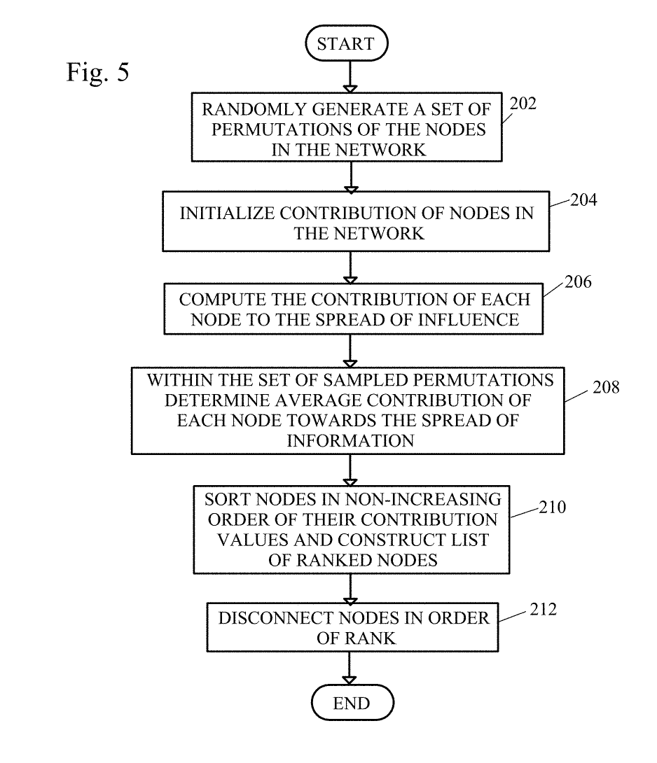

FIG. 5 shows a flow diagram of a method of model independent ranking and network structure driven ranking if nodes of limiting the spread of misinformation through location based social networks. Under each discussion of the steps of the method is corresponding pseudocode.

The definition of terms in the following steps can be represented in pseudocode as:
Let ´Ω be a set of t randomly sampled permutations.
Let Πⱼ be the j-th permutation in ´Ω.
Let R be the number of repetitions.
Let Sᵢ(Πⱼ) represent the set of nodes that occur before node i in the permutation Πⱼ.
Let MC[i] represent the marginal contribution of node i.
Let SHᵢ represent the Shapley value of node
Let v₁ and v₂ represent value functions which assign a value for each subset S of nodes in the network

In a first step (step 202), a set ´Ω of permutations of the nodes of the targeted social network are randomly generated by misinformation management function 96 of the workload layer 90 cloud computing environment.

The contributions of the sets of nodes in the targeted social network are initialized by the misinformation management function 96 (step 204). Following the order of the nodes dictated by Πᵢ, initially all nodes of the network are inactive and a threshold is randomly assigned to each node. This can be represented in pseudocode as:
for i=1 to n do
   set MC[i]←0
end for

A random node, for example node Π₁, is activated. The method then determines how many nodes are activated because of the activation of Π₁. The determination of how many nodes are activated because of node Π₁ is the contribution of node Π₁. The next node i=2 is considered. If node Π₂ is already activated due to the activation of node Π₁, then the contribution of node Π₂ is zero. Otherwise, node Π₂ is activated. The method then determines how many nodes are activated because of the activation of Π₂. This becomes the contribution of the node Π₂. This process continues up to node Πₙ.

Then, the contributions of each node to the spread of influence are computed (step 206), for example by the misinformation management function 96 from a graph of the nodes prior to extraction of the targeted portion of the social network 102. The spread of influence may be determined by calculating a Shapley value.

Step 206 is repeated R times using the same starting node Π₁. Furthermore, the contribution of the sets of nodes are repeated for each permutation in the set of sampled permutations.

Step 206 may be represented in pseudocode as follows:

for k=1 to R

for j=1 to t do

for i=1 to n do

MC[i] ← MC[i] + νₙ(Sᵢ(πⱼ) ∪ {i}) − νₙ(Sᵢ(πⱼ))

end for

end for

end for

The values of vₙ in the formula of step 206 may be calculated in several ways, with n refers to the version used to calculate the contribution of each node to the spread of influences.

In a first embodiment, the model Γ₁ used to calculate the contribution of each node to the spread of influences is calculated as any subset S of the edges is the inverse of the sum of squares of the cardinalities of the connected nodes after removing the nodes and edges in S from the original given graph G(N, E(N)). In one embodiment v₁ assigns a value to each subset S of the nodes.

We define the first version of game Γ₁=(N, v₁) as follows:

For each S⊂N define v₁(S) to be:

$${v}_{1} ( S ) = \frac{1}{{\sum }_{i ∈ φ ( S )} \vert {C}_{i} \vert 2}$$

Where N is the set of nodes in the targeted, social network
Where S is any subset of N.
Where C is the cardinality of i
Where Φ(S)={1, 2, . . . k} is the set of nodes for the k connected nodes in G(N\S, E(N\S))

In an alternate embodiment, the model Γ₂ used to calculate the contribution of each node to the spread of influences is calculated as the ratio of the number of connected nodes to the sum of cardinalities of the connected nodes after move the nodes in S as well as the edges among the nodes in S from the original given graph G(N, E(N)). In the alternate embodiment v₂ assigns a value to each subset S of the nodes.

We define the second version of game Γ₂=(N, v₂) as follows:

For each S⊂ N define v₂(S) to be:

$${v}_{2} ( S ) = \frac{k}{\vert {C}_{1} \vert + \vert {C}_{2} \vert + ⋯ + \vert {C}_{k} \vert}$$

Where N is the set of nodes in the targeted, social network
Where S is any subset of N.
Where C is the cardinality of connected nodes
Where Φ(S)={1, 2, . . . k} is the set of indices
   for the k connected components in G(N\S, E(N\S))

Within the set of sampled permutations, the average contribution of each nodes towards the spread of information is determined by the misinformation management function 96 of the workload layer 90 cloud computing environment (step 208). The marginal contribution of node i of a randomly sampled set t is then determined.

Step 208 can be represented in pseudocode as:

for i=1 to n do

$$compute {SH}_{i} ← \frac{MC [ i ]}{t}$$

end for

The nodes are sorted, for example by their Shapley values, in a non-increasing order of their contribution values and a list of ranked nodes is constructed (step 210).

The number of nodes to be disconnected may be determined by the misinformation management function 96 of the workload layer 90 cloud computing environment. Given k nodes to be disconnected, as given in the input, the top k nodes in the sorted order are disconnected.

The nodes are disconnected in order of rank (step 212) and the method ends.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of limiting misinformation spread through a social network structure using a ranking of nodes of a targeted portion of a social network, comprising the steps of:
a computer randomly generating a set of permutations of the nodes of the targeted social network;
the computer computing a contribution to the spread of influence of each node within the set of randomly generated permutations;
the computer, determining the average contribution of each of the nodes towards a spread of information within the network;
the computer constructing a list of ranked nodes by sorting the nodes in a non-increasing order based on contribution values; and
the computer disconnecting at least some of the nodes in order of rank in the list.

2. The method of claim 1, wherein the step of computing a contribution comprises determining the inverse of a sum of squares of cardinalities of connected nodes after removing the nodes and connections between the nodes in the set from a social network prior to being filtered.

3. The method of claim 1, wherein the step of computing a contribution comprises determining a ratio between a number of nodes to a sum of cardinalities of the connected nodes after removing the nodes and connections between the nodes in the set from a social network prior to being filtered.

4. The method of claim 1, wherein the targeted portion of a social network of nodes affected by the misinformation is determined by the steps of:
receiving input regarding the misinformation;
receiving input regarding portions of the social network which are sensitive towards the misinformation;
receiving input regarding a location base of a user of the social network which includes the social network; and
removing the nodes of the social network which do not correspond to the input received.

5. The method of claim 1, wherein the contribution value defines a level of impact when multiple nodes interact together.

6. The method of claim 1, wherein ranking of the list of ranked nodes is model independent.

7. A computer program product for limiting misinformation spread through a social network structure using a ranking of nodes of a targeted portion of a social network, the computer program product comprising a computer comprising at least one processor, one or more memories, one or more computer readable storage media, the computer program product comprising a computer readable storage medium having program instructions embodied therewith, the program instructions executable by the computer to perform a method comprising:
randomly generating, by the computer, a set of permutations of the nodes of the targeted social network;
computing, by the computer, a contribution to the spread of influence of each node within the set of randomly generated permutations;
determining, by the computer, the average contribution of each of the nodes towards a spread of information within the network;
constructing, by the computer, a list of ranked nodes by sorting the nodes in a non-increasing order based on contribution values; and
disconnecting, by the computer, at least some of the nodes in order of rank in the list.

8. The computer program product of claim 7, wherein the program instructions of computing, by the computer, a contribution comprises determining the inverse of a sum of squares of cardinalities of connected nodes after removing the nodes and connections between the nodes in the set from a social network prior to being filtered.

9. The computer program product of claim 7, wherein the program instructions of computing, by the computer, a contribution comprises determining a ratio between a number of nodes to a sum of cardinalities of the connected nodes after removing the nodes and connections between the nodes in the set from a social network prior to being filtered.

10. The computer program product of claim 7, wherein the targeted portion of a social network of nodes affected by the misinformation is determined by the program instructions of:
receiving, by the computer, input regarding the misinformation;
receiving, by the computer, input regarding portions of the social network which are sensitive towards the misinformation;
receiving, by the computer, input regarding a location base of a user of the social network which includes the social network; and
removing, by the computer, the nodes of the social network which do not correspond to the input received.

11. The computer program product of claim 7, wherein the contribution value defines a level of impact when multiple nodes interact together.

12. The computer program product of claim 7, wherein the ranking of the list of ranked nodes is model independent.

13. A computer system for limiting misinformation spread through a social network structure using a ranking of nodes of a targeted portion of a social network, the computer system comprising a computer comprising at least one processor, one or more memories, one or more computer readable storage media having program instructions executable by the computer to perform the program instructions comprising:
randomly generating, by the computer, a set of permutations of the nodes of the targeted social network;
computing, by the computer, a contribution to the spread of influence of each node within the set of randomly generated permutations;
determining, by the computer, the average contribution of each of the nodes towards a spread of information within the network;
constructing, by the computer, a list of ranked nodes by sorting the nodes in a non-increasing order based on contribution values; and
disconnecting, by the computer, at least some of the nodes in order of rank in the list.

14. The computer system of claim 13, wherein the program instructions of computing, by the computer, a contribution comprises determining the inverse of a sum of squares of cardinalities of connected nodes after removing the nodes and connections between the nodes in the set from a social network prior to being filtered.

15. The computer system of claim 13, wherein the program instructions of computing, by the computer, a contribution comprises determining a ratio between a number of nodes to a sum of cardinalities of the connected nodes after removing the nodes and connections between the nodes in the set from a social network prior to being filtered.

16. The computer system of claim 13, wherein the targeted portion of a social network of nodes affected by the misinformation is determined by the program instructions of:
receiving, by the computer, input regarding the misinformation;
receiving, by the computer, input regarding portions of the social network which are sensitive towards the misinformation;
receiving, by the computer, input regarding a location base of a user of the social network which includes the social network; and
removing, by the computer, the nodes of the social network which do not correspond to the input received.

17. The computer system of claim 13, wherein the contribution value defines a level of impact when multiple nodes interact together.

18. The computer system of claim 13, wherein the ranking of the list of ranked nodes is model independent.
